(19) United States
(12) Patent Application Publication
(10) Pub. No.: US 2026/0226300 A1
(43) Pub. Date: Aug. 6, 2026

(54) BINDER FOR INKJET PRINTING INKS, INKJET PRINTING INK, AND PRINTED ARTICLE

(71) Applicant: DIC Corporation, Tokyo (JP)

(72) Inventors: Wakana Naito, Takaishi-shi (JP); Shinya Yamamoto, Takaishi-shi (JP)

(73) Assignee: DIC Corporation, Tokyo (JP)

(21) Appl. No.: 19/148,061

(22) PCT Filed: Feb. 1, 2024
(86) PCT No.: PCT/JP2024/003205

§ 371 Date: Jul. 15, 2025

(30) Foreign Application Priority Data
Feb. 16, 2023 (JP) 2023-022378

(51) Int. Cl. C09D 11/38

(52) U.S. Cl. CPC C09D 11/38

(57) ABSTRACT

The present invention provides a binder for inkjet printing inks, the binder containing an aqueous urethane resin composition, the composition containing a urethane resin containing a polyol compound, a polyisocyanate compound, and a neutralizing agent as essential raw materials, and an aqueous medium, wherein the polyol compound has an aromatic ring concentration in a range of 2000 to 5000 mmol/kg; the polyol compound contains a polyester polyol containing terephthalic acid and/or isophthalic acid as a raw material; the neutralizing agent contains an alkali metal hydroxide; and the urethane resin has an acid value in a range of 30 to 60 mg KOH/g. The binder for inkjet printing inks has excellent storage stability, dischargeability, and scratch resistance.

### TECHNICAL FIELD

The present invention relates to a binder for inkjet printing inks that can form an inkjet printing ink having excellent storage stability, dischargeability, and scratch resistance, an inkjet printing ink containing the binder for inkjet printing inks, and a printed article produced by printing with the inkjet printing ink.

### BACKGROUND ART

In recent years, in rapidly growing inkjet printing-related fields, higher performance of inkjet printers, improvement in inks, and the like are making rapid advancement, and it is becoming possible to obtain an image as high gloss and high definition as a film photo easily in ordinary households. Especially, for inks, improvement to achieve higher image quality and reduction in environmental load, such as shift to pigment inks from known dye inks and shift to an aqueous system from a solvent system, have been rapidly advanced and, now, development using an aqueous pigment ink as a base has been actively carried out.

Furthermore, the inks are required to have various performances year by year as higher performances of inkjet printers and the like are achieved. Examples thereof include discharging stability of inks, which does not cause clogging of an ink discharging nozzle constituting an inkjet printer over time and which does not cause discharging failure and abnormality of discharging direction of inks over a long period of time; and blending stability that does not cause separation or aggregation over time of inks produced by mixing a binder resin with a pigment or a dye and other additives.

As an inkjet printing ink having excellent ink dischargeability and blending stability, for example, an ink composition at least containing a pigment, water, polymer particles of a water-insoluble vinyl polymer, which contain the pigment and allow dispersion of the pigment in the ink composition, and a urethane resin, and use of a mixture of the ink composition and acetylene glycols, which are surfactants, are known (e.g., see Patent document 1).

However, even the ink composition does not have satisfactory dischargeability and blending stability at significantly high levels that are required in the industry, and clogging of an ink discharging nozzle over time and the like may occur when the ink is used for a long period of time.

Meanwhile, while even a higher level of scratch resistance is required as a wider range of fields uses inkjet printed articles, the ink composition described in Patent Document 1 has problems of causing discoloration, deterioration, or damage of a printed image due to fall off of the pigment or the like when, for example, a strong external force is applied locally.

Thus, a material having even superior storage stability, dischargeability, and scratch resistance has been demanded.

### CITATION LIST

### Patent Document

Patent Document 1: JP 2006-282760 A

### SUMMARY OF INVENTION

### Technical Problem

In order to solve the problems described above, an object of the present invention is to provide a binder for inkjet printing inks that can form an inkjet printing ink having excellent storage stability, dischargeability, and scratch resistance, an inkjet printing ink containing the binder for inkjet printing inks, and a printed article produced by printing with the inkjet printing ink.

### Solution to Problem

As a result of intensive studies to solve the problems described above, the present inventors have found that the problems described above can be solved by using a specific urethane resin containing a specific polyol compound and a specific neutralizing agent, and have completed the present invention.

Accordingly, the present invention relates to a binder for an inkjet printing ink, the binder containing an aqueous urethane resin composition containing a urethane resin (A) containing a polyol compound (a1), a polyisocyanate compound (a2), a chain extender (a3), and a neutralizing agent (a4) as essential raw materials, and an aqueous medium (B), wherein the polyol compound (a1) has an aromatic ring concentration in a range of 2000 to 5000 mmol/kg; the polyol compound (a1) contains a polyester polyol containing terephthalic acid and/or isophthalic acid as a raw material; the neutralizing agent (a4) contains an alkali metal hydroxide; and the urethane resin (A) has an acid value in a range of 30 to 60 mg KOH/g; an inkjet printing ink containing the binder for an inkjet printing ink; and a printed article produced by printing with the inkjet printing ink.

### Advantageous Effects of Invention

Because the binder for inkjet printing inks of the present invention has excellent storage stability, dischargeability, and scratch resistance, the binder for inkjet printing inks can be used suitably as an inkjet printing ink.

### DESCRIPTION OF EMBODIMENTS

The binder for inkjet printing inks of the present invention is characterized by containing an aqueous urethane resin composition containing a urethane resin (A) and an aqueous medium (B).

The urethane resin (A) to be used is a urethane resin containing a polyol compound (a1), a polyisocyanate compound (a2), a chain extender (a3), and a neutralizing agent (a4) as essential raw materials.

As the polyol compound (a1), a polyester polyol is essentially used.

The polyester polyol is a polyester polyol obtained by subjecting a polycarboxylic acid and a polyhydric alcohol to an esterification reaction. As the polycarboxylic acid, at least one of terephthalic acid or isophthalic acid is used. Furthermore, as the polyester polyol, a polyester polyol containing no acid group is preferred because a binder for inkjet printing inks that can form an inkjet printing ink having excellent storage stability, dischargeability, and scratch resistance can be obtained.

As the polycarboxylic acid, an additional polycarboxylic acid can be used in combination, besides terephthalic acid and isophthalic acid. Examples of the additional polycarboxylic acid include: aromatic dicarboxylic acids, such as phthalic acid, isophthalic acid, terephthalic acid, naphthalenedicarboxylic acid, and esters thereof; and aliphatic dicarboxylic acids, such as succinic acid, glutaric acid, adipic acid, maleic acid, pimelic acid, suberic acid, azelaic acid, itaconic acid, sebacic acid, chlorendic acid, 1,2,4-butane-tricarboxylic acid, decanedicarboxylic acid, cyclohexanedicarboxylic acid, dimer acid, fumaric acid, and esters thereof. These polycarboxylic acids or esters thereof may be used alone or in combination of two or more types thereof.

Examples of the polyhydric alcohol include: aromatic diols, such as benzenedimethanol, toluenedimethanol, and xylenedimethanol; and aliphatic polyols, such as ethylene glycol, propylene glycol, 1,3-propylenediol, 1,4-butanediol, 1,6-hexanediol, 1,8-octanediol, diethylene glycol, triethylene glycol, cyclohexane-1,4-diol, cyclohexane-1,4-dimethanol, and neopentyl glycol ethylene glycol. These polyhydric alcohols may be used alone or in combination of two or more types thereof.

In the esterification reaction during production of the polyester polyol, an esterification catalyst is preferably used to promote the esterification reaction. Examples of the esterification catalyst include: metals, such as titanium, tin, zinc, aluminum, zirconium, magnesium, hafnium, and germanium; and metal compounds, such as titanium tetraisopropoxide, titanium tetrabutoxide, titanium oxyacetylacetonate, dibutyltin oxide, dibutyltin diacetate, dibutyltin dilaurate, tin octanoate, tin 2-ethylhexanoate, zinc acetylacetonate, zirconium tetrachloride, a zirconium tetrachloride tetrahydrofuran complex, hafnium tetrachloride, a hafnium tetrachloride tetrahydrofuran complex, germanium oxide, and tetraethoxygermanium. These esterification catalysts may be used alone or in combination of two or more types thereof.

The aromatic ring concentration of the polyol compound (a1) is in a range of 2000 to 5000 mmol/kg and, because a binder for inkjet printing inks that can form an inkjet printing ink having excellent storage stability, dischargeability, and scratch resistance can be obtained, is preferably in a range of 2500 to 5000, and more preferably in a range of 3000 to 4500.

Furthermore, as the polyol compound (a1), as necessary, another polyol compound other than the polyester polyol can be also used.

Examples of such another polyol compound include polyether polyols, polyester polyols other than the polyester polyol described above, polyester ether polyols, and polycarbonate polyols. These polyol compounds may be used alone or in combination of two or more types thereof.

Examples of the polyether polyol include a polyether polyol obtained by addition-polymerizing an alkylene oxide using one type or two or more types of compounds containing two or more active hydrogen atoms as an initiator.

Examples of the initiator include ethylene glycol, diethylene glycol, triethylene glycol, propylene glycol, trimethylene glycol, 1,3-butanediol, 1,4-butanediol, 1,6-hexanediol, glycerin, trimethylolethane, and trimethylolpropane.

Examples of the alkylene oxide include ethylene oxide, propylene oxide, butylene oxide, styrene oxide, epichlorohydrin, and tetrahydrofuran.

Examples of the polyether polyol include polyoxytetramethylene glycol, polypropylene glycol, and polyethylene glycol. Furthermore, because a binder for inkjet printing inks that can form an inkjet printing ink having excellent storage stability, dischargeability, and scratch resistance can be obtained, the number average molecular weight of the polyether polyol is preferably in a range of 1000 to 3000.

Examples of the polyester polyol include polyester polyols obtained by subjecting a polycarboxylic acid other than the terephthalic acid and the isophthalic acid and a polyhydric alcohol to an esterification reaction.

Examples of such polycarboxylic acid other than the terephthalic acid and the isophthalic acid include: aromatic dicarboxylic acids, such as phthalic acid, naphthalenedicarboxylic acid, and esters thereof; and aliphatic dicarboxylic acids, such as succinic acid, glutaric acid, adipic acid, maleic acid, pimelic acid, suberic acid, azelaic acid, itaconic acid, sebacic acid, chlorendic acid, 1,2,4-butane-tricarboxylic acid, decanedicarboxylic acid, cyclohexanedicarboxylic acid, dimer acid, fumaric acid, and esters thereof. These polycarboxylic acids or esters thereof may be used alone or in combination of two or more types thereof.

As the polyhydric alcohol, polyhydric alcohols same as those exemplified for the polyhydric alcohol described above can be used.

Examples of the polyester ether polyol include a polyester ether polyol obtained by reacting a polycarboxylic acid and a polyether polyol, in which an alkylene oxide is added to an initiator. As the initiator, initiators same as those exemplified for the initiator described above can be used. As the alkylene oxide, alkylene oxides same as those exemplified for the initiator described above can be used. Furthermore, as the polycarboxylic acid, polycarboxylic acids same as those exemplified for the other polycarboxylic acid described above can be used in addition to the terephthalic acid and the isophthalic acid.

Examples of the polycarbonate polyol include a polycarbonate polyol obtained by reacting a carbonic ester and a polyol, and a polycarbonate polyol obtained by reacting phosgene and bisphenol A. Examples of the carbonic ester include methyl carbonate, dimethyl carbonate, ethyl carbonate, diethyl carbonate, cyclocarbonate, and diphenyl carbonate. Examples of the polyol that can react with the carbonic ester include: dihydroxy compounds having a relatively low molecular weight, such as ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentanediol, 1,5-hexanediol, 2,5-hexanediol, 1,6-hexanediol, 1,7-heptanediol, 1,8-octanediol, 1,9-nonanediol, 1,10-decanediol, 1,11-undecanediol, 1,12-dodecanediol, 3-methyl-1,5-pentanediol, 2-ethyl-1,3-hexanediol, 2-methyl-1,3-propanediol, 2-methyl-1,8-octanediol, 2-butyl-2-ethylpropanediol, 2-methyl-1,8-octanediol, 1,4-cyclohexanediol, 1,4-cyclohexanedimethanol, hydroquinone, resorcin, bisphenol-A, bisphenol-F, and 4,4′-biphenol; polyether polyols, such as polyethylene glycol, polypropylene glycol, and polytetramethylene glycol; and polyester polyols, such as polyhexamethylene adipate, polyhexamethylene succinate, and polycaprolactone.

Because a binder for inkjet printing inks that can form an inkjet printing ink having excellent storage stability, dischargeability, and scratch resistance can be obtained, the content of the polyol compound (a1) is preferably in a range of 0 to 80 mass %, and more preferably in a range of 5 to 70 mass %, in the raw materials of the urethane resin (A).

Examples of the polyisocyanate compound (a2) include: aromatic polyisocyanates, such as phenylene diisocyanate, toluene diisocyanate, diphenylmethane diisocyanate, xylylene diisocyanate, naphthalene diisocyanate, polymethylene polyphenyl polyisocyanate, and carbodiimidized diphenylmethane polyisocyanate; aliphatic polyisocyanates, such as hexamethylene diisocyanate, lysine diisocyanate, cyclohexane diisocyanate, isophorone diisocyanate, dicyclohexylmethane diisocyanate, xylylene diisocyanate, tetramethylxylylene diisocyanate, dimer acid diisocyanate, and norbornene diisocyanate; and alicyclic diisocyanates, such as norbornane diisocyanate, isophorone diisocyanate, hydrogenerated xylylene diisocyanate and hydrogenerated diphenylmethane diisocyanate. These polyisocyanate compounds may be used alone or in combination of two or more types thereof.

Because a binder for inkjet printing inks that can form an inkjet printing ink having excellent storage stability, dischargeability, and scratch resistance can be obtained, the content of the polyisocyanate compound (a2) is preferably in a range of 10 to 60 mass %, and more preferably in a range of 20 to 50 mass %, in the raw materials of the urethane resin (A).

As the neutralizing agent (a3), an alkali metal hydroxide is used. Examples of the alkali metal hydroxide include sodium hydroxide and potassium hydroxide.

As the neutralizing agent (a3), as necessary, a neutralizing agent other than the alkali metal hydroxide (hereinafter, may be referred to as “additional neutralizing agent”) can be used together.

Examples of the additional neutralizing agent include triethylamine, ammonia, morpholine, monoethanolamine, and diethylethanolamine.

Because a binder for inkjet printing inks that can form an inkjet printing ink having excellent storage stability, dischargeability, and scratch resistance can be obtained, the used amount of the neutralizing agent (a3) is preferably in a range of 1 to 15 mass %, and more preferably in a range of 2 to 10 mass %, in the raw materials of the urethane resin (A).

As the urethane resin (A), as necessary, a chain extender (a4) can be also used.

Examples of the chain extender (a4) include: diamines such as ethylenediamine, 1,2-propanediamine, 1,6-hexamethylenediamine, piperazine, 2,5-dimethylpiperazine, isophoronediamine, 4,4′-dicyclohexylmethanediamine, 3,3′-dimethyl-4,4′-dicyclohexylmethanediamine, and 1,4-cyclohexanediamine; diamines containing one primary amino group and one secondary amino group, such as N-hydroxymethylaminoethylamine, N-hydroxyethylaminoethylamine, N-hydroxypropylaminopropylamine, N-ethylaminoethylamine, and N-methylaminopropylamine; polyamines, such as diethylenetriamine, dipropylenetriamine, and triethylenetetramine; hydrazines, such as hydrazine, N,N′-dimethylhydrazine, and 1,6-hexamethylene bishydrazine; dihydrazides, such as succinic acid dihydrazide, adipic acid dihydrazide, glutaric acid dihydrazide, sebacic acid dihydrazide, and isophthalic acid dihydrazide; and semicarbazides, such as β-semicarbazidopropionic acid hydrazide, 3-semicarbazide-propyl-carbazate, and semicarbazide-3-semicarbazidomethyl-3,5,5-trimethylcyclohexane. These chain extenders may be used alone or in combination of two or more types thereof.

The acid value of the urethane resin (A) is in a range of 30 to 60 mg KOH/g and, because a binder for inkjet printing inks that can form an inkjet printing ink having excellent storage stability, dischargeability, and scratch resistance can be obtained, is preferably in a range of 35 to 55 mg KOH/g, and more preferably in a range of 40 to 55 mg KOH/g.

A method for producing the urethane resin (A) is not particularly limited, and the urethane resin (A) may be produced by any method. For example, the urethane resin (A) may be produced by a method in which all reaction raw materials including the polyol compound (a1), the polyisocyanate compound (a2), and the neutralizing agent (a3) are reacted at once, or may be produced by a method in which the reaction raw materials are sequentially reacted.

Examples of the aqueous medium (B) include ion-exchanged water and distilled water. These aqueous mediums may be used alone or in combination of two or more types thereof.

A method for producing the aqueous urethane resin composition is not particularly limited, and the aqueous urethane resin composition may be produced by any method. Examples of the method include a method in which the urethane resin (A) and the aqueous medium (B) are mixed.

Examples of the method of mixing the urethane resin (A) and the aqueous medium (B) include a method in which mixing is performed using a reactor equipped with a stirring blade; a kneading machine, such as a kneader, a continuous kneader, a taper roll, a single-screw extruder, a twin-screw extruder, a triple-screw extruder, a universal mixer, Plastomill, or a Bodeda kneading machine; a rotary dispersion mixing machine, such as a homomixer, a static mixer, Filmix, Ebara Milder, ClearMix, ULTRA-TURRAX, Cavitron, or BioMixer; an ultrasonic dispersion apparatus; or an apparatus having no moving portion and capable of mixing by the flow of a fluid itself, such as an in-line mixer.

Because a binder for inkjet printing inks that can form an inkjet printing ink having excellent storage stability, dischargeability, and scratch resistance can be obtained, the mass ratio of the urethane resin (A) to the aqueous medium (B) [(A)/(B)] is preferably in a range of 50/50 to 80/20, and more preferably in a range of 50/50 to 70/30.

The aqueous urethane resin composition of the present invention may contain another additive, as necessary.

Examples of such another additive include a surfactant, an emulsifier, a thickener, a urethanization catalyst, a filler, a flame retardant, a leveling agent, and an antiblocking agent. These additives may be used alone or in combination of two or more types thereof.

Examples of the surfactant include: nonionic surfactants, such as polyoxyethylene nonylphenyl ether, polyoxyethylene lauryl ether, polyoxyethylene styrylphenyl ether, polyoxyethylene sorbitol tetraoleate, and polyethylene/polypropylene copolymer; anionic surfactants, such as fatty acid salts such as sodium oleate, alkylsulfuric acid ester salts, alkylbenzenesulfonates, alkylsulfosuccinates, naphthalenesulfonates, polyoxyethylene alkylsulfates, alkanesulfonate sodium salts, and alkyldiphenylethersulfonate sodium salts; and cationic surfactants, such as alkylamine salts, alkyltrimethylammonium salts, and alkyldimethylbenzylammonium salts.

Examples of the emulsifier include: nonionic emulsifiers, such as polyoxyethylene nonylphenyl ether, polyoxyethylene lauryl ether, polyoxyethylene styrylphenyl ether, polyoxyethylene sorbitol tetraoleate, and polyethylene/polypropylene copolymer; anionic emulsifiers, such as fatty acid salts such as sodium oleate, alkylsulfuric acid ester salts, alkylbenzenesulfonates, alkylsulfosuccinates, naphthalenesulfonates, polyoxyethylene alkylsulfates, alkanesulfonate sodium salts, and alkyldiphenylethersulfonate sodium salts; and cationic emulsifiers, such as alkylamine salts, alkyltrimethylammonium salts, and alkyldimethylbenzylammonium salts. These emulsifiers may be used alone or in combination of two or more types thereof.

Examples of the thickener include an associative thickener and an acid-based thickener.

Examples of the urethanization catalyst include an organotin-based catalyst and a bismuth-based catalyst.

Examples of the filler include calcium carbonate and silica.

Examples of the flame retardant include a phosphorus-based flame retardant.

Examples of the leveling agent include a silicon-based leveling agent.

Examples of the antiblocking agent include an acrylic antiblocking agent and a cellulose ester.

The binder for inkjet printing inks of the present invention is made of the aqueous urethane resin composition.

The inkjet printing ink of the present invention is an ink containing, in addition to the binder for inkjet printing inks, a pigment and/or a dye, and optional various additives.

As the pigment, for example, a known inorganic pigment or organic pigment can be used.

Examples of the inorganic pigment include titanium oxide, antimony red, red iron oxide, cadmium red, cadmium yellow, cobalt blue, Prussian blue, ultramarine, carbon black, and graphite.

Examples of the organic pigment include quinacridone-based pigments, quinacridonequinone-based pigments, dioxazine-based pigments, phthalocyanine-based pigments, anthrapyrimidine-based pigments, anthanthrone-based pigments, indanthrone-based pigments, flavanthrone-based pigments, perylene-based pigments, diketopyrrolopyrrole-based pigments, perinone-based pigments, quinophthalone-based pigments, anthraquinone-based pigments, thioindigo-based pigments, benzimidazolone-based pigments, and azo-based pigments.

These pigments may be used alone or in combination of two or more types thereof. Furthermore, these pigments may be surface-treated and may be self-dispersible in an aqueous medium.

Examples of the dyes include azo dyes, such as monoazo and disazo, metal complex salt dyes, naphthol dyes, anthraquinone dyes, indigo dyes, carbonium dyes, quinoneimine dyes, cyanine dyes, quinoline dyes, nitro dyes, nitroso dyes, benzoquinone dyes, naphthoquinone dyes, naphthalimide dyes, perinone dyes, phthalocyanine dyes, and triarylmethane-based dyes.

Examples of the additive include a polymer dispersing agent, a viscosity modifier, a humectant, a defoaming agent, a surfactant, an antiseptic, a pH adjuster, a chelating agent, a plasticizer, a UV absorber, and an antioxidant as well as acrylic resin and the like used in binders of known inkjet printing inks.

Examples of the polymer dispersing agent include acrylic resins and styrene-acrylic resins, and any random type, block type, or graft type of these can be used. When the polymer dispersing agent is used, an acid or a base may be used together to neutralize the polymer dispersing agent.

As the dispersing agent, an acrylic resin or styrene-acrylic resin having a weight average molecular weight of preferably 1000 to 50000, and more preferably 1000 to 20000, can be used. Furthermore, as the dispersing agent, a dispersing agent having an acid value of preferably 100 to 500, and more preferably 100 to 200, can be used.

As the acrylic resin and the styrene-acrylic resin, a polymer of acrylic acid or methacrylic acid, a polymer of these and styrene, and the like can be used.

As the styrene-acrylic resin, use of a styrene-acrylic resin obtained by using from 50 mass % to 95 mass % of styrene with respect to the total amount of monomers used in the production thereof is preferred.

The inkjet printing ink can be prepared by, for example, the following production method.
(1) A method of preparing an ink by mixing the pigment or the dye, the aqueous medium, the binder for inkjet printing inks, and the optional additive at once by using various dispersing devices.
(2) A method of preparing an ink by preparing an ink precursor made of an aqueous dispersion of a pigment or a dye by mixing the pigment or the dye and the aqueous medium, and the optional additive at once by using various dispersing devices; and then mixing the ink precursor made of the aqueous dispersion of the pigment or the dye, the binder for inkjet printing inks, and the optional aqueous medium and the optional additive by using various dispersing devices.

The ink precursor containing the pigment used in the method for producing the ink described in (2) above can be prepared by, for example, the following method.
(i) A method of preparing an ink precursor made of the aqueous dispersion containing the pigment by mixing the aqueous medium and a kneaded material, which is obtained by preliminarily kneading the pigment and an additive such as the dispersing agent using two rolls, a mixer, or the like, by using various dispersing devices.
(ii) A method of preparing an ink precursor made of the aqueous dispersion containing the pigment by mixing the pigment and the dispersing agent using various dispersing devices, then allowing the dispersing agent to deposit on a surface of the pigment by controlling solubility of the dispersing agent, and further mixing this by using a dispersing device.
(iii) A method of preparing an ink precursor made of the aqueous dispersion containing the pigment by mixing the pigment and the additive by using various dispersing devices, and then mixing the mixture and a resin emulsion by using a dispersing device.

As the dispersing device that can be used for production of the inkjet printing ink, for example, one type or a combination of two or more types of an ultrasonic homogenizer, a high-pressure homogenizer, a paint shaker, a ball mill, a roll mill, a sand mill, a sand grinder, a DYNO-MILL, a DISPERMAT, an SC mill, and/or a Nanomizer can be used.

The inkjet printing ink obtained by the method may contain coarse particles having a particle size of approximately 250 nm or greater. Because the coarse particle may cause clogging of a printer nozzle or the like and deterioration of ink discharging properties, after preparation of the aqueous dispersion of the pigment or after preparation of the ink, the coarse particle is preferably removed by a method, such as centrifugation or filtration treatment.

The inkjet printing ink obtained as described above preferably has a volume average particle size of 200 nm or less and, particularly in a case where an image having an even higher gloss similar to photographic quality is formed, the volume average particle size is more preferably in a range of 80 to 120 nm.

Furthermore, the inkjet printing ink preferably contains from 0.2 to 10 mass % of the polyurethane (C), from 50 to 95 mass % of the aqueous medium, and from 0.5 to 15 mass % of the pigment or the dye with respect to the total amount of the inkjet printing ink.

The inkjet printing ink of the present invention obtained by the method can be used for inkjet printing simply using an inkjet printer and can be used for inkjet printing on a base material, such as paper, a plastic film, a metal film, or a sheet. Although the system of inkjet is not particularly limited, a known system, such as a continuous injection system (e.g., charge control type, spraying type) or an on-demand system (e.g., piezo system, thermal system, electrostatic attraction system), can be applied.

The printed article printed by using the inkjet printing ink of the present invention is less likely to cause deterioration of printed image or the like due to fall off of a pigment or the like because the printed article has excellent scratch resistance, can prevent occurrence of blur or the like when an alkaline detergent or the like is attached to a printed image surface because the printed article has excellent resistance to alkali, and has an image with a high color optical density, and thus the image can be used for various purposes, such as photoprinting by an inkjet printing and printed articles obtained by high speed printing by inkjet printing.

### EXAMPLES

The present invention will be specifically described with reference to Examples and Comparative Examples below. Note that the present invention is not limited to the following Examples.

### Synthesis Example 1: Synthesis of Polyester Polyol (1)

In a reaction vessel equipped with a thermometer, a nitrogen gas introduction tube, and a stirrer, while a nitrogen gas is introduced, 5.8 parts by mass of ethylene glycol, 10.0 parts by mass of diethylene glycol, 13.8 parts by mass of terephthalic acid, 13.8 parts by mass of isophthalic acid, and 0.1 parts by mass of dibutyltin oxide were charged and subjected to a polycondensation reaction at 230° C. until the acid value became 0.1 or less, and thus a polyester polyol (1) was obtained.

### Synthesis Examples 2 to 7: Synthesis of Polyester Polyols (2) to (7)

Polyester polyols (2) to (8) were obtained in the same manner as in Synthesis Example 1 using compositions listed in Table 1.

The compositions of the polyester polyols (1) to (8) obtained in Synthesis Examples 1 to 8 are listed in Table 1.

TABLE 1

| | | Synthesis | Synthesis | Synthesis | Synthesis | Synthesis | Synthesis | Synthesis | Synthesis |
|---|---|---|---|---|---|---|---|---|---|
| | | Example | Example | Example | Example | Example | Example | Example | Example |
| | | 1 | 2 | 3 | 4 | 5 | 6 | 7 | 8 |
| Polyester polyol | | (1) | (2) | (3) | (4) | (5) | (6) | (7) | (8) |
| Composition | Ethylene glycol | 5.8 | 10.1 | 2.8 | 6.1 | 6.6 | 11.7 | | |
| (parts by mass) | Diethylene glycol | 10 | 17.3 | | 10.4 | 11.3 | 19.9 | | |
| | Neopentyl glycol | | | 9.2 | | | | | 4.2 |
| | 1,6-Hexanediol | | | 5.3 | | | | | 11.3 |
| | 1,4-Butanediol | | | | | | | 25.7 | |
| | Dimethylolpropionic acid | | | | | | | | 5.1 |
| | Terephthalic acid | 13.8 | 23.9 | | 14.4 | 15.6 | 27.5 | | |
| | Isophthalic acid | 13.8 | 23.9 | 15.8 | 14.4 | 15.6 | 27.5 | | |
| | Adipic acid | | | 3.5 | | | | 36.9 | 22.7 |
| | Sebacic acid | | | 8.0 | | | | | |

| | | | | | | | | |
|---|---|---|---|---|---|---|---|---|
| Acid value (mg KOH/g) | 0 | 0 | 0 | 0 | 0 | 0 | 0 | 39 |
| Aromatic ring concentration (mmol/kg) | 4460 | 4460 | 2421 | 4460 | 4460 | 4460 | 0 | 0 |
| Number average molecular weight | 1700 | 1700 | 2000 | 1700 | 1700 | 1700 | 2000 | 2000 |
| Tg (° C.) | 14 | 14 | -21 | 14 | 14 | 14 | −31 | −29 |

### Example 1: Preparation of Aqueous Urethane Resin Composition (1)

In a four-neck flask equipped with a thermometer, a stirring device, a reflux condenser, and a nitrogen introduction tube, 43.4 parts by mass of the polyester polyol obtained in Synthesis Example 1 using the composition listed in Table 1, 18.1 parts by mass of the polyether polyol (“PTMG 1000”, available from Mitsubishi Chemical Corporation), and 7.3 parts by mass of dimethylolpropionic acid were placed and adequately stirred. Then, 26.9 parts by mass of a polyisocyanate compound (1) IPDI and 0.1 parts by mass of dibutyltin dilaurate as a catalyst were added and reacted at 75° C. After the reaction, MEK was added in a manner that the MEK made the solid content concentration 60%, and the mixture was stirred for 30 minutes and cooled to 40° C. or lower, and thus a urethane resin solution was obtained. Then, a neutralizing agent was added to the obtained urethane resin solution to neutralize the acid group. Then, ion-exchanged water was added in a manner that the solid content concentration became 20% while the mixture was vigorously stirred. After the urethane was emulsified, a chain extender was added. After the reaction was completed, the MEK was removed by distillation under reduced pressure, and thus an aqueous urethane resin composition (1) having the solid content concentration of 30% was obtained.

### Examples 2 to 4: Preparation of Aqueous Urethane Resin Compositions (2) to (4)

Aqueous urethane resin compositions (2) to (4) were obtained in the same manner as in Example 1 using compositions listed in Table 1.

### Comparative Examples 1 to 5: Preparation of Aqueous Urethane Resin Compositions (R1) to (R5)

Aqueous urethane resin compositions (R1) to (R5) were obtained in the same manner as in Example 1 using compositions listed in Table 1.

TABLE 2

| | | | | | | | Compar- | Compar- | Compar- | Compar- | Compar- |
|---|---|---|---|---|---|---|---|---|---|---|---|
| | | | | | | | ative | ative | ative | ative | ative |
| | | | Example | Example | Example | Example | Example | Example | Example | Example | Example |
| | | | 1 | 2 | 3 | 4 | 1 | 2 | 3 | 4 | 5 |
| Aqueous urethane resin composition | | | (1) | (2) | (3) | (4) | (R1) | (R2) | (R3) | (R4) | (R5) |
| Composition | Urethane | Polyester polyol (1) | 43.4 | | | | | | | | |
| (parts | resin | Polyester polyol (2) | | 75.2 | | | | | | | |
| by mass) | | Polyester polyol (3) | | | 44.6 | | | | | | |
| | | Polyester polyol (4) | | | | 45.3 | | | | | |
| | | Polyester polyol (5) | | | | | | 49.1 | | | |
| | | Polyester polyol (6) | | | | | | | 86.6 | | |
| | | Polyester polyol (7) | | | | | | | | 62.6 | |
| | | Polyester polyol (8) | | | | | | | | | 43.3 |
| | | Polyether polyol | 18.1 | | 17.7 | 17.8 | 61.5 | 19.4 | | | 18.2 |
| | | (PTMG 1000) | | | | | | | | | |
| | | 1,4-Butanediol | | | | | | | | 3.4 | |
| | | Polyisocyanate | 26.9 | 14.6 | 26.3 | 23.4 | 26.9 | 23.1 | | | 26.9 |
| | | compound (1) IPDI | | | | | | | | | |
| | | Polyisocyanate | | | | | | | 11.0 | | |
| | | compound (2) HDI | | | | | | | | | |
| | | Polyisocyanate | | | | | | | | 25.9 | |
| | | compound (3) TDI | | | | | | | | | |
| | | Dimethylolpropionic | 7.3 | 7.3 | 7.1 | 9.7 | 7.3 | 5.2 | 2.1 | 4.1 | 7.3 |
| | | acid | | | | | | | | | |
| | | Chain extender | 1.4 | | 1.4 | | 1.4 | 1.2 | | | 1.4 |
| | | (hydrazine) | | | | | | | | | |
| | | Chain extender | | | | | | | | 3.4 | |
| | | (piperazine) | | | | | | | | | |
| | | Neutralizing agent | 2.9 | 2.9 | 2.9 | 3.8 | 2.9 | 2 | | | 2.9 |
| | | (1) KOH | | | | | | | | | |
| | | Neutralizing agent | | | | | | | 0.3 | 0.6 | |
| | | (2) TEA | | | | | | | | | |

| | | | | | | | | | |
|---|---|---|---|---|---|---|---|---|---|
| Aqueous medium | 2333 | 2333 | 2333 | 2333 | 2333 | 2333 | 2333 | 2333 | 2333 |

| | | | | | | | | | |
|---|---|---|---|---|---|---|---|---|---|
| Urethane acid value (mg KOH/g) | 30 | 30 | 30 | 40 | 30 | 20 | 9 | 18 | 20 |

### Example 5: Preparation of Inkjet Printing Ink (1)

In a 0.5 L jacketed tank of a mini planetary mixer (“mini-PLM”, available from Aicohsha Mfg. Co., Ltd.), 50 parts by mass of C.I. pigment red 122 (“FASTOGEN Super Magenta RY”, available from DIC Corporation) and 10 parts by mass of a styrene-acrylic acid copolymer (weight average molecular weight: 11000; acid value: 180 mg KOH/g) were charged in this order and stirred at a rotational speed of 80 rpm and a revolving speed of 25 rpm for 10 minutes in a condition where the temperature of the jacketed tank was increased to 80° C.

Then, in a condition where the temperature of the jacketed tank was maintained at 80° C., 5.3 parts by mass of a 34 mass % potassium hydroxide aqueous solution and 30 parts by mass of triethylene glycol were added to the composition and kneaded at a rotational speed of 80 rpm and a revolving speed of 25 rpm for 60 minutes, and thus a solid kneaded material was obtained.

To the kneaded material, 100 parts by mass of ion-exchanged water and 10 parts by mass of triethylene glycol were added and stirred and mixed for 10 minutes by a juicer-mixer. By mixing the ion-exchanged water and Proxel-GXL (available from Lonza Japan), an aqueous pigment dispersion having a pigment concentration of 15.0 mass %, a triethylene glycol concentration of 12.0 mass %, a Proxel-GXL concentration of 0.1 mass %, and a non-volatile content of 18.2 mass % was obtained.

20.0 parts by mass of the aqueous pigment dispersion, 8.0 parts by mass of 2-pyrrolidinone, 8.0 parts by mass of triethylene glycol mono-n-butyl ether, 3.0 parts by mass of glycerin, and 0.5 parts by mass of SURFYNOL 440 (available from Air Products) were mixed. Then, to the mixture, 1.5 parts by mass, in terms of solid content, of the binder for inkjet printing inks (1) made of the aqueous urethane resin composition (1) obtained in Example 1 was added. The mixture was then adjusted by ion-exchanged water in a manner that the pigment concentration became 3.0% and the urethane solid content concentration became 1.5%, and thus an inkjet printing ink (1) was obtained.

### Examples 6 to 8: Preparation of Inkjet Printing Inks (2) to (4)

Each of inkjet printing inks (2) to (4) was obtained in the same manner as in Example 5 except for changing the binder for inkjet printing inks (1) made of the aqueous urethane resin composition (1) used in Example 5 to each of the binders for inkjet printing inks (2) to (4) made of the aqueous urethane resin compositions (2) to (4) obtained in Examples 2 to 4.

### Comparative Examples 6 to 10: Preparation of Inkjet Printing Inks (R1) to (R5)

Each of inkjet printing inks (R1) to (R5) was obtained in the same manner as in Example 5 except for changing the binder for inkjet printing inks (1) made of the aqueous urethane resin composition (1) used in Example 5 to each of the binders for inkjet printing inks (R1) to (R5) made of the aqueous urethane resin compositions (R1) to (R5) obtained in Comparative Examples 1 to 5.

The following evaluations were performed by using the inkjet printing inks (1) to (4) and (R1) to (R5) obtained in Examples and Comparative Examples described above.

### Evaluation Method of Storage Stability

A particle size of a sample obtained by storing each of the inkjet printing inks obtained in Examples and Comparative Examples in an environment at 60° C. for 1 week was measured, and the percentage of change (%) was calculated based on the following expression and evaluated based on the following criteria. Note that a case where the evaluation result was A or B was determined as having practically adequate storage stability.

$$Percentage of change ( \% ) : ( particle size after heat acceleration ) / ( particle size before heat acceleration ) \times 100$$

A: The percentage of change was 95% or greater and less than 106%.
B: The percentage of change was 90% or greater and less than 95% or 106% or greater and less than 111%.
C: The percentage of change was 85% or greater and less than 90% or 111% or greater and less than 116%.
D: The percentage of change was less than 85% or 116% or greater.

### Evaluation Method of Ink Dischargeability

Each of the inkjet printing inks obtained in Examples and Comparative Examples was charged in a black ink cartridge of a commercially available inkjet printer (“ENVY 4500”, available from Hewlett-Packard). Then, printing was performed on all over a transparent OHP sheet at a printing density setting of 100%, and thus a printed article for evaluation was obtained. Using an unprinted OHP sheet as a reference, an absorbance (value at a maximum peak around 536 nm) of the printed face of the OHP sheet was measured. By comparing the absorbance with that of an ink containing no binder, a dischargeability index was calculated based on the following expression and evaluated based on the following criteria. Note that a case where the evaluation result was A or B was determined as having practically adequate dischargeability.
Dischargeability index: (absorbance of ink containing binder)/(absorbance of ink containing no binder)
A: The dischargeability index was 0.80 or greater.
B: The dischargeability index was 0.70 or greater and less than 0.80.
C: The dischargeability index was 0.60 or greater and less than 0.70.
D: The dischargeability index was less than 0.60.

### Evaluation Method of Scratch Resistance

Each of the inkjet printing inks obtained in Examples and Comparative Examples was applied to photoprinting paper (“HP Advanced Photo Paper”, available from Hewlett-Packard) using a bar coater #3, and thus a printed article for testing was obtained. After the printed article was dried at room temperature for 1 day, friction test was performed using a Gakushin type rubbing fastness tester. At the time of the test, a plain paper was attached to an arm for rubbing, and the arm was moved back and forth for 20 cycles under a load of 200 g. The condition of the rubbed printed face was visually observed and evaluated based on the following criteria. Note that a case where the evaluation result was A or B was determined as having practically adequate scratch resistance.
A: No scratch was on the printed face, and the coloring material was not peeled off.
B: Slight scratches were on the printed surface but the coloring material was not peeled off.
C: Remarkable scratches were on the printed surface, and the coloring material was also peeled off.

The compositions and evaluation results for the inkjet printing inks (1) to (4) and (R1) to (R5) obtained in Examples and Comparative Examples described above are listed in Table 3.

TABLE 3

| | | | | | | Compar- | Compar- | Compar- | Compar- | Compar- |
|---|---|---|---|---|---|---|---|---|---|---|
| | | | | | | ative | ative | ative | ative | ative |
| | | Example | Example | Example | Example | Example | Example | Example | Example | Example |
| | | 5 | 6 | 7 | 8 | 6 | 7 | 8 | 9 | 10 |
| Inkjet printing ink | | (1) | (2) | (3) | (4) | (R1) | (R2) | (R3) | (R4) | (R5) |
| Evaluation | Storage stability | A | B | B | A | A | B | B | D | D |
| item | Dischargeability | B | A | A | A | A | C | D | D | C |
| | Scratch | A | A | A | A | C | B | B | C | B |
| | resistance | | | | | | | | | |

Examples 5 to 8 listed in Table 3 were examples using the binders for inkjet printing inks of the present invention. It was confirmed that these inkjet printing inks had excellent storage stability, dischargeability, and scratch resistance.

On the other hand, Comparative Example 6 listed in Table 3 is an example of an inkjet printing ink containing the binder for inkjet printing inks using the urethane resin containing no polyester polyol as the polyol compound. It was confirmed that this inkjet printing ink had remarkably unsatisfactory scratch resistance although storage stability and dischargeability were excellent.

Comparative Example 7 is an example of an inkjet printing ink containing the binder for inkjet printing inks using the urethane resin having the acid value that was not in the range of 30 to 60 mg KOH/g. It was confirmed that this inkjet printing ink had remarkably unsatisfactory dischargeability.

Comparative Example 8 is an example of an inkjet printing ink containing the binder for inkjet printing inks using the urethane resin containing no alkali metal hydroxide as the neutralizing agent. It was confirmed that this inkjet printing ink had remarkably unsatisfactory dischargeability.

Comparative Example 9 is an example of an inkjet printing ink containing the binder for inkjet printing inks using no alkali metal hydroxide as the neutralizing agent and using the urethane resin containing no terephthalic acid and no isophthalic acid as the raw materials of the polyester polyol. It was confirmed that this inkjet printing ink had remarkably unsatisfactory storage stability, dischargeability, and scratch resistance.

Comparative Example 10 is an example of an inkjet printing ink containing the binder for inkjet printing inks using the urethane resin containing no terephthalic acid and no isophthalic acid as the raw materials of the polyester polyol. It was confirmed that this inkjet printing ink had remarkably unsatisfactory storage stability and dischargeability.

1. A binder for an inkjet printing ink, the binder comprising an aqueous urethane resin composition containing
a urethane resin (A) containing a polyol compound (a1), a polyisocyanate compound (a2), and a neutralizing agent (a3) as essential raw materials, and
an aqueous medium (B), wherein
the polyol compound (a1) has an aromatic ring concentration in a range of 2000 to 5000 mmol/kg;
the polyol compound (a1) contains a polyester polyol containing terephthalic acid and/or isophthalic acid as a raw material;
the neutralizing agent (a3) contains an alkali metal hydroxide; and
the urethane resin (A) has an acid value in a range of 30 to 60 mg KOH/g.

2. The binder for an inkjet printing ink according to claim 1, wherein the polyester polyol has a number average molecular weight in a range of 500 to 3000.

3. The binder for an inkjet printing ink according to claim 1, wherein the urethane resin (A) further contains a chain extender (a4) as a raw material.

4. The binder for an inkjet printing ink according to claim 1, wherein the alkali metal hydroxide is sodium hydroxide and/or potassium hydroxide.

5. The binder for an inkjet printing ink according to claim 1, wherein the polyester polyol contains no acid group.

6. An inkjet printing ink comprising the binder for an inkjet printing ink described in claim 1 and a pigment or a dye.

7. A printed article produced by printing with the inkjet printing ink described in claim 6.
